(19) United States
(12) Patent Application Publication
(10) Pub. No.: US 2010/0090572 A1
(43) Pub. Date: Apr. 15, 2010

(54) Product delivery bin for a vending machine

(75) Inventor: David Charles Dunnigan, Buffalo, MN (US)

Correspondence Address: DOCKET CLERK, P.O. DRAWER 800889, DALLAS, TX, 75380, US

(73) Assignee: DIXIE-NARCO, INC., Williston, SC (US)

(21) Appl. No.: 12/287,844

(22) Filed: Oct. 14, 2008

(51) Int. Cl. A47B 96/00; B23P 11/00

(52) U.S. Cl. 312/326; 29/428

(57) ABSTRACT

A system and method for providing an improved product delivery bin for a vending machine is disclosed. A vending machine cabinet is provided with a door assembly that is capable of being placed in a closed position with respect to the vending machine cabinet. The product delivery bin of the vending machine comprises a door panel of the door assembly and a cabinet bin panel of the vending machine cabinet. The product delivery bin is formed when the door assembly is in a closed position with respect to the vending machine cabinet. The product delivery bin is accessible through a bin access door in the door assembly.

### TECHNICAL FIELD OF THE INVENTION

The present invention is directed, in general, to vending machines and, more particularly, to an improved product delivery bin for a vending machine.

### BACKGROUND OF THE INVENTION

Vending machines for dispensing canned and/or bottled beverages have long been known. Early model vending machines release similarly sized bottles, one at a time, following deposit of a required purchase amount. In order to withdraw the selected bottle from the vending machine, a purchaser was required to, for example, slide the bottle along a track until reaching a release point at which time the bottle could be removed from the machine. While effective, differences in bottle design, size and shape made it necessary to develop specific product vending machines. However, over time, packaging beverages in cans gained in popularity. The standardization of product containers brought on through the use of beverage cans made vending simpler. Many vending machine designs employed serpentine tracks that not only increases storage capacity but improves the overall efficiency of the vending operation.

Presently, product containers are once again available in various different sizes and shapes. Specialty beverages, such as sports and energy drinks, flavored teas, fruit juices, milk and the like, are growing in popularity. Typically, these beverages are packaged in glass or plastic bottles that have unique shapes which are associated with the particular product. Given the wide variety of container sizes, mechanisms for delivering the selected product to a consumer must be readily adaptable or capable of accommodating a large number of different products. At present, transport mechanisms that transition in multiple planes to deliver a selected product to a consumer are growing in popularity. Typically, the selected product is either retrieved from a shelf or allowed to pass into a carrier portion of the transport mechanism whereupon the transport carrier is shifted toward a dispensing area.

Once at the dispensing area, the product must be discharged from the transport carrier. Various mechanisms have been employed to discharge a selected product from a transport carrier into a dispensing area. In one example, the product is simply run along a conveyor belt into the dispensing area. In other examples, the selected product is gently placed in the dispensing area. In still other arrangements, the product is simply ejected from the transport carrier and allowed to fall within the vending machine cabinet into the dispensing area.

In many vending machines, the dispensing area is located laterally offset from the product storage area. That is, the product storage area is defined between left and right upstanding inner walls, with products being discharged through one of the walls into a laterally spaced compartment located below a validator unit. With this arrangement, the product storage area is necessarily reduced in it lateral dimension. Other vending machines simply drop products to a lower retrieval chamber which is accessible through a frontal zone of the vending machine. Although these known arrangements enable the full width of the vending machine to be used for product storage, considerable measures must be taken to assure adequate protection from product theft through the frontal zone.

After a consumer has selected a product and paid the purchase price, the vending machine discharges the product into a product delivery bin. The consumer retrieves the product from the product delivery bin through a bin access door through the door assembly of the vending machine. The manufacture of a prior art product delivery bin generally requires numerous manufacturing steps, numerous constituent parts, and significant assembly costs.

Therefore, there is a need in the art for an improved product delivery bin for a vending machine that can be manufactured (1) with significantly fewer steps than a prior art product delivery bin, and (2) with significantly fewer parts than a prior art product delivery bin, and (3) with significantly less cost than a prior art product delivery bin. There exists a need for an improved product delivery bin for vending machines.

### SUMMARY OF THE INVENTION

The product delivery bin of the present invention is intended for use in a vending machine that comprises a vending machine cabinet that has a top, bottom, rear and opposing side portions. The vending machine cabinet defines a product storage zone. The vending machine cabinet is provided with a door assembly that is capable of being placed in a closed position with respect to the vending machine cabinet.

The product delivery bin of the invention comprises a door panel of the door assembly and a cabinet bin panel of the vending machine cabinet. The product delivery bin is formed when the door assembly is in a closed position with respect to the vending machine cabinet. The product delivery bin is accessible through a bin access door in the door assembly.

Additional objects, features and advantages of the present invention will become more readily apparent from the following detailed description of preferred embodiments when taken in conjunction with the drawings wherein like reference numerals refer to corresponding parts in the several views.

### BRIEF DESCRIPTION OF THE DRAWINGS

FIG. 1 is an upper right, exploded view of a prior art vending machine incorporating a prior art product delivery bin in the product dispensing area of the vending machine;

FIG. 2 is an upper right, exploded view of a vending machine incorporating a product delivery bin of the present invention;

FIG. 3 is a front view of a vending machine incorporating a product delivery bin of the present invention; and

FIG. 4 is a detailed cross sectional view of a product delivery bin of the present invention taken along the line A-A of the vending machine shown in FIG. 3.

### DETAILED DESCRIPTION

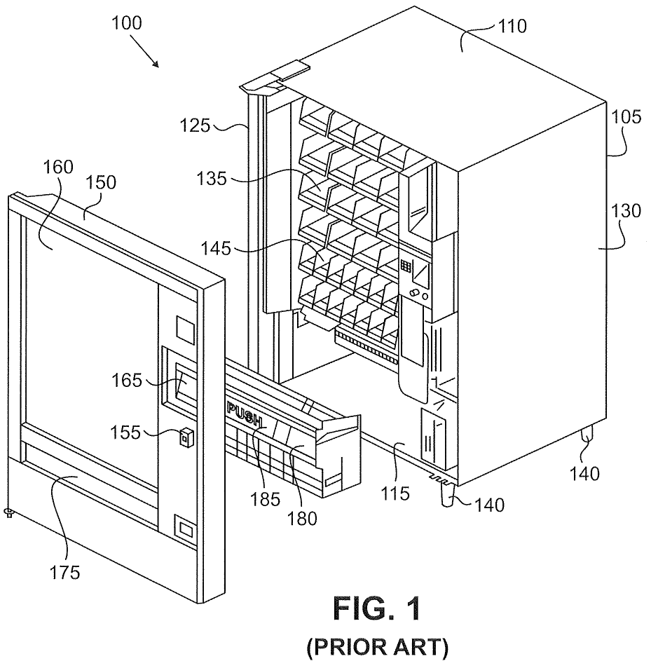

FIGS. 1 through 4 and the various embodiments used to describe the principles of the present invention in this patent document are by way of illustration only and should not be construed in any way to limit the scope of the invention. Those skilled in the art will understand that the principles of the invention may be implemented in any type of suitably arranged vending machine.

FIG. 1 is an upper right, exploded view of a prior art vending machine 100. The vending machine 100 comprises a vending machine cabinet 105 having a top portion 110, a bottom portion 115, a rear portion (not shown in FIG. 1), and opposing side portions 125 and 130 that collectively define an internal product storage zone 135. Vending machine 100 also includes a plurality of leg members 140 for supporting vending machine cabinet 105 on a floor surface. Vending machine 100 further includes a plurality of shelves 145 that support various product containers. Each product shelf 145 includes a plurality of laterally spaced product queues, each having a respective release mechanism (not shown) for releasing a selected product to a consumer.

A door assembly 150 is pivotally mounted to vending machine cabinet 105. A portion of door assembly 150 is connected to vending machine cabinet 105 through a hinge mechanism (not shown) to selectively provide access to product storage zone 135. Door assembly 150 is also provided with a lock mechanism 155 that prevents unauthorized access to product storage zone 135.

Door assembly 150 is provided with a transparent window 160 that allows consumers to see and choose between the various products that are offered by vending machine 100. In connection with making a selection, a consumer deposits a purchase price into a currency receiving zone 165. Currency receiving zone 165 generally comprises a bill acceptor/validator unit, a coin slot, and a coin return area. Following the deposit of the purchase price and the selection of a desired product, vending machine 100 initiates a vending operation that results in the delivery of the selected product to a product dispensing area. In order to retrieve the selected product from the product dispensing area, the consumer simply accesses the product dispensing area through an opening 175 provided on the door assembly 150.

The product dispensing area is enclosed by a product delivery bin 180. As shown in FIG. 1, the product delivery bin 180 is a separate unit that is located under the product storage zone 135 of vending machine cabinet 105. A typical prior art product delivery bin 180 is manufactured as a complete subassembly unit. The product delivery bin 180 subassembly is manufactured from sheet metal material, plastic material, and/or other appropriate manufacturing materials. The product delivery bin 180 comprises a bin access door 185 that is pivotally mounted on the product delivery bin 180. The bin access door 185 is aligned with the opening 175 on the door assembly 150. When a consumer desires to retrieve a selected product from the product delivery bin 180, the consumer manually pushes inwardly on the bin access door 185. The consumer then retrieves the selected product from the bottom of the product delivery bin 180.

The assembly of the prior art product delivery bin 180 requires a number of manufacturing steps. The present invention provides a product delivery bin for a vending machine that can be manufactured with significantly fewer steps than a prior art product delivery bin 180. The present invention also provides a product delivery bin for a vending machine that can be manufactured with significantly fewer parts than a prior art product delivery bin 180. The present invention also provides a product delivery bin for a vending machine that can be manufactured with less cost than a prior art product delivery bin 180.

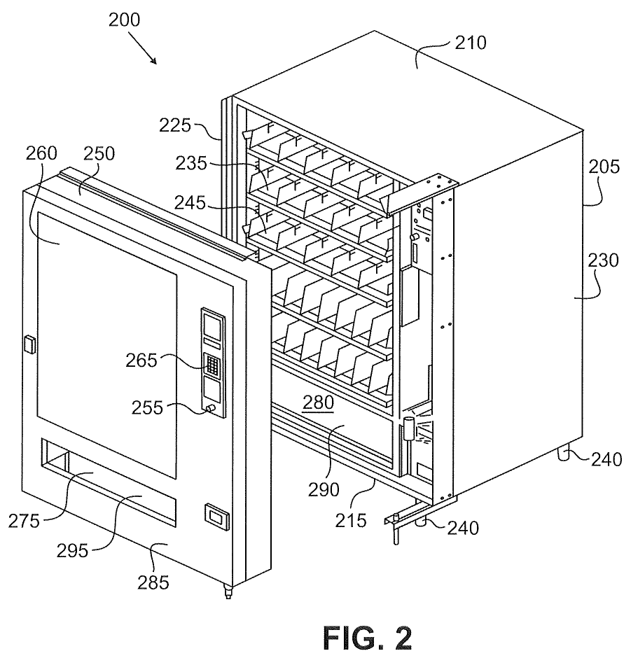

FIG. 2 is an upper right, exploded view of a vending machine 200 incorporating a product delivery bin 280 of the present invention. The vending machine 200 comprises a vending machine cabinet 205 having a top portion 210, a bottom portion 215, a rear portion (not shown in FIG. 2), and opposing side portions 225 and 230 that collectively define an internal product storage zone 235. Vending machine 200 also includes a plurality of leg members 240 for supporting vending machine cabinet 205 on a floor surface. Vending machine 200 further includes a plurality of shelves 245 that support various product containers. Each product shelf 245 includes a plurality of laterally spaced product queues, each having a respective release mechanism (not shown) for releasing a selected product to a consumer.

A door assembly 250 is pivotally mounted to vending machine cabinet 205. A portion of door assembly 250 is connected to vending machine cabinet 205 through a hinge mechanism (not shown) to selectively provide access to product storage zone 235. Door assembly 250 is also provided with a lock mechanism 255 that prevents unauthorized access to product storage zone 235.

Door assembly 250 is provided with a transparent window 260 that allows consumers to see and choose between the various products that are offered by vending machine 200. In connection with making a selection, a consumer deposits a purchase price into a currency receiving zone 265. Currency receiving zone 265 generally comprises a bill acceptor/validator unit, a coin slot, and a coin return area. Following the deposit of the purchase price and the selection of a desired product, vending machine 200 initiates a vending operation that results in the delivery of the selected product to a product dispensing area. In order to retrieve the selected product from the product dispensing area, the consumer simply accesses the product dispensing area through an opening 275 provided on the door assembly 250.

The product dispensing area comprises a product delivery bin 280. As shown in FIG. 2, the product delivery bin 280 is located under the product storage zone 235 of vending machine cabinet 205. The product delivery bin 280 of the present invention is formed from a door panel 285 of the door assembly 250 and from a cabinet bin panel 290 of the vending machine cabinet 205. As will be more fully described, the door panel 285 and the cabinet bin panel 290 cooperate to form the product delivery bin 280 when the door assembly 250 is in its closed position with respect to the vending machine cabinet 205.

The product delivery bin 280 also comprises a bin access door 295 that is pivotally mounted on the door assembly 250 in alignment with the opening 275 of the door assembly 250. When a consumer desires to retrieve a selected product from the product delivery bin 280, the consumer manually pushes inwardly on the bin access door 295. The consumer then retrieves the selected product from the bottom of the product delivery bin 280.

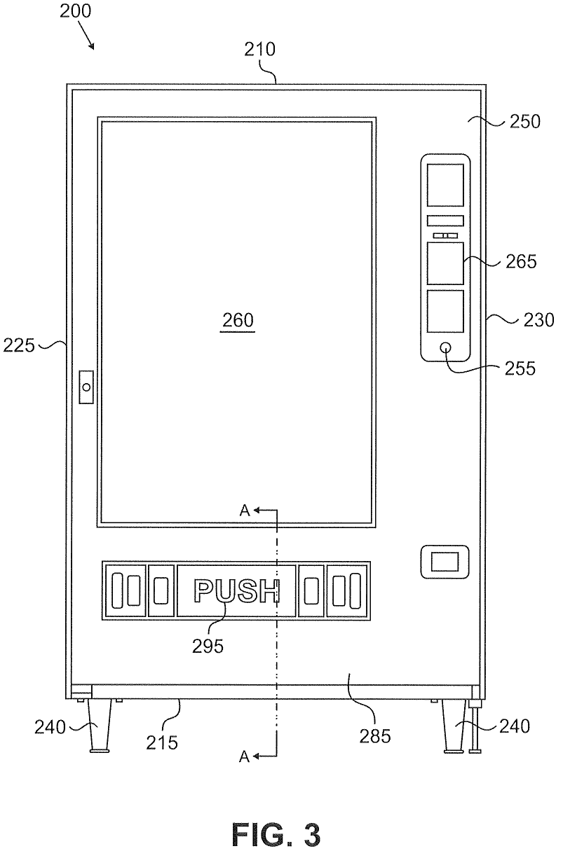

FIG. 3 is a front view of the vending machine 200 of the present invention that incorporates a product delivery bin 280 of the present invention. FIG. 3 illustrates a view that shows the door assembly 250 in a closed position with respect to the vending machine cabinet 205. The bin access door 295 is shown in a closed position. The letters PUSH are placed on the bin access door 295 to show the consumer where to push on the bin access door 295.

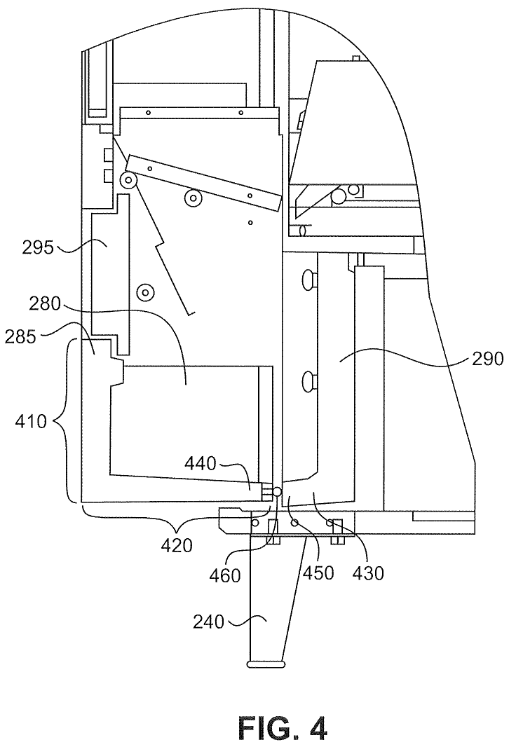

FIG. 4 is a detailed cross sectional view of the product delivery bin 280 of the present invention taken along the line A-A of the vending machine 200 shown in FIG. 3. As shown in FIG. 4, the bin access door 295 and the door panel 285 comprise the front of the product delivery bin 280. The door panel 285 also comprises a portion of the bottom of the product delivery bin 280. The door panel 285 also comprises the sides (not shown in FIG. 4) of the product delivery bin 280. The front portion of the door panel 285 is designated with reference numeral 410 and the bottom portion of the door panel 285 is designated with reference numeral 420.

The cabinet bin panel 290 comprises the back of the product delivery bin 280. The cabinet bin panel 290 also comprises a portion of the bottom of the product delivery bin 280. The cabinet bin panel 290 also comprises the sides (not shown in FIG. 4) of the product delivery bin 280. The bottom portion of the cabinet bin panel 290 is designated with reference numeral 430.

As shown in FIG. 4, when the door assembly 250 is in a closed position with respect to vending machine cabinet 205, an edge 440 of the bottom portion 420 of the door panel 285 is adjacent to an edge 450 of the bottom portion 430 of the cabinet bin panel 290. An appropriate sealing mechanism 460 (such as an O-ring) may be affixed either to the edge 440 or to the edge 450 to provide a sealed closure between the door panel 285 and the cabinet bin panel 290 when the door assembly 250 is in a closed position with respect to vending machine cabinet 205.

The elements of the door panel 285 that have been described and the elements of the cabinet bin panel 290 that have been described operate together to form the product delivery bin 280 of the present invention. The present invention provides a product delivery bin 280 for a vending machine 200 that can be manufactured with significantly fewer steps than a prior art product delivery bin 180. This is because the product delivery bin 280 of the invention comprises fewer parts than the prior art product delivery bin 180. Because the product delivery bin 280 of the invention comprises fewer parts than a prior art delivery bin 180, the product delivery bin 280 of the invention can be manufactured with less cost than the prior art product delivery bin 180. For the reasons set forth above, the product delivery bin 280 of the invention provides significant benefits for the vending machine manufacturing industry.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of the invention, as defined by the following claims.

What is claimed is:

1. A vending machine that comprises:
a vending machine cabinet;
a door assembly that is capable of being placed in a closed position with respect to the vending machine cabinet; and
a product delivery bin within the vending machine cabinet that comprises a door panel of the door assembly and a cabinet bin panel of the vending machine cabinet.

2. The vending machine as set forth in claim 1 wherein the door assembly comprises a bin access door that opens into the product delivery bin.

3. The vending machine as set forth in claim 1 wherein the door panel comprises portions that form a front portion of the product delivery bin and portions that form a portion of the bottom of the product delivery bin.

4. The vending machine as set forth in claim 3 wherein door panel comprises portions that form at least one side portion of the product delivery bin.

5. The vending machine as set forth in claim 1 wherein the cabinet bin panel comprises portions that form a back portion of the product delivery bin and portions that form a portion of the bottom of the product delivery bin.

6. The vending machine as set forth in claim 5 wherein cabinet bin panel comprises portions that form at least one side portion of the product delivery bin.

7. The vending machine as set forth in claim 1 wherein an edge of a bottom portion of the door panel is adjacent to an edge of a bottom portion of the cabinet bin panel when the door assembly is in a closed position with respect to the vending machine cabinet.

8. The vending machine as set forth in claim 7 comprising a sealing mechanism between the edge of the bottom portion of the door panel and the edge of the bottom portion of the cabinet bin panel.

9. The vending machine as set forth in claim 8 wherein the sealing mechanism is an O-ring.

10. The vending machine as set forth in claim 7 wherein the door assembly comprises a bin access door that opens into the product delivery bin.

11. A method of manufacturing a vending machine, said method comprising the steps of:
providing a vending machine cabinet;
attaching a door assembly to the vending machine cabinet wherein the door assembly is capable of being placed in a closed position with respect to the vending machine cabinet; and
forming a product delivery bin within the vending machine cabinet that comprises a door panel of the door assembly and a cabinet bin panel of the vending machine cabinet.

12. The method as set forth in claim 11 further comprising the step of:
providing within the door assembly a bin access door that opens into the product delivery bin.

13. The method as set forth in claim 11 further comprising the steps of:
forming a front portion of the product delivery bin with a portion of the door panel; and
forming a portion of the bottom of the product delivery bin with a portion of the door panel.

14. The method as set forth in claim 13 further comprising the step of:
forming at least one side portion of the product delivery bin with a portion of the door panel.

15. The method as set forth in claim 11 further comprising the steps of:
forming a back portion of the product delivery bin with a portion of the cabinet bin panel; and
forming a portion of the bottom of the product delivery bin with a portion of the cabinet bin panel.

16. The method as set forth in claim 15 further comprising the step of:
forming at least one side portion of the product delivery bin with a portion of the cabinet bin panel.

17. The method as set forth in claim 1 wherein an edge of a bottom portion of the door panel is adjacent to an edge of a bottom portion of the cabinet bin panel when the door assembly is in a closed position with respect to the vending machine cabinet.

18. The method as set forth in claim 17 further comprising the step of:
placing a sealing mechanism between the edge of the bottom portion of the door panel and the edge of the bottom portion of the cabinet bin panel.

19. The method as set forth in claim 18 wherein the sealing mechanism is an O-ring.

20. The method as set forth in claim 17 further comprising the step of:
providing within the door assembly a bin access door that opens into the product delivery bin.
